(19) United States
(12) Patent Application Publication
(10) Pub. No.: US 2021/0230908 A1
(43) Pub. Date: Jul. 29, 2021

(54) LOCK, FITTING, STRIKE PLATE AND CLOSING DEVICE FOR SLIDING DOORS AND SLIDING DOOR SYSTEM

(71) Applicant: HAWA SLIDING SOLUTIONS AG, Mettmenstetten (CH)

(72) Inventors: Sascha JUSTL, Zürich (CH); Beat KURIGER, Trachslau (CH); Peter ETTMÜLLER, Jonen (CH); Gregor HAAB, Allenwinden (CH); Marianne BEYELER, Alchenflüh (CH); Martin NUE, Villigen (CH); Stefan AUER, Langenthal (CH); Bruno RÄZ, Messen (CH)

(73) Assignee: HAWA SLIDING SOLUTIONS AG, Mettmenstetten (CH)

(21) Appl. No.: 17/050,682

(22) PCT Filed: May 23, 2019
(86) PCT No.: PCT/EP2019/063284

§ 371 Date: Oct. 26, 2020

(30) Foreign Application Priority Data
May 24, 2018 (CH) 00653/18

(51) Int. Cl. E05B 65/08; E05B 47/00

(52) U.S. Cl. CPC E05B 65/0858; E05B 47/004

(57) ABSTRACT

A lock, a fitting and a strike plate, in addition to a closing device for sliding doors, allow frontal or lateral locking of a sliding door. Further a sliding door system has a closing device.

### TECHNICAL FIELD OF THE INVENTION

The present invention relates to a closing device for sliding doors. The present invention relates in particular to a closing device that allows lateral and frontal locking of sliding doors. Furthermore, the present invention also relates to a lock for sliding doors that can be frontally and laterally installed and operated and that allows lateral and frontal locking of sliding doors. It also relates to a strike plate of the inventive closing device. Furthermore, the present invention also relates to a fitting that can be used to operate an inventive lock, regardless of whether the lock is installed frontally or laterally. Finally, the invention also relates to a sliding door system that comprises an inventive closing device and/or an inventive lock.

### PRIOR ART

Closing devices for sliding doors, that comprise a fitting, a lock and a strike plate, are already known in a wide variety of embodiments. In particular, self-locking locks are known, i.e. locks that are capable of locking doors automatically after each closing and that have a flush design when the door is open, i.e. when the lock bolt is retracted.

However, the locks of the prior art known for example from DE102007041402A1, have several drawbacks. The fitting for operating the lock is normally connected directly to the lock at the same spot. It would however be desirable to be able to install the fitting at a spatially remote and often more convenient position in the door, as this would offer technical and aesthetic advantages.

Furthermore, sliding door locks are known that are suitable for either frontal or lateral installation and locking. However, if, for example, sliding doors are to be provided with both locking variants, two different types of sliding door locks are required, which entails considerable manufacturing and storage costs.

### SUMMARY OF THE INVENTION

The object of the present invention is therefore to overcome the drawbacks of the prior art referred to above and to provide an improved closing device for sliding doors in addition to an improved sliding door system incorporating such a closing device.

In particular, a closing device and a sliding door system shall be provided which selectively allow frontal or lateral locking.

Moreover, it is also an object of the present invention to provide a lock that can optionally be installed and operated frontally or laterally. The invention also aims to propose a strike plate with which optimum locking of the lock can be achieved. Furthermore, it is also an object of the present invention to provide a fitting by means of which the inventive lock can advantageously be operated, regardless of whether the inventive lock is installed frontally or laterally in a door.

According to the present invention, all of the above objects are achieved by the solutions defined in the independent claims. Advantageous embodiments of the invention are defined in dependent claims and disclosed in the description.

In particular, the objects of the present invention are achieved by a lock comprising a housing, a circular bolt, which is rotatable around a pivot axis from an extended position to a retracted position and a sledge system, through which rotation of the circular bolt from the extended position to the retracted position can be effected.

The lock is characterised in that the sledge system comprises a longitudinal sledge and a transverse sledge, wherein rotation of the circular bolt from the extended position to the retracted position is triggerable by displacing the longitudinal sledge towards the circular bolt, in that the longitudinal sledge and the transverse sledge interact in such a manner that displacement of the longitudinal sledge towards the circular bolt can be effected by displacing the transverse sledge perpendicularly thereto and in that rotation of the circular bolt from the extended position to the retracted position can be effected by either an impact force exerted on the longitudinal sledge or by a tractive force exerted on the transverse sledge.

Owing to these features, the inventive lock can be installed and operated either on the front or the side of a door. This versatility represents a distinct advantage over the prior art, as the same lock can be used in a variety of situations. The lock is highly flexible in terms of installation and operation and is therefore accessible to a wide range of applications. There is no need to purchase and store locks that only allow a certain installation or operation.

In a further preferred embodiment of the invention, a closing plate is provided, which is movable from a locked position, in which rotation of the circular bolt from the extended position to the retracted position is inhibited, to an unlocked position, in which the circular bolt is rotatable from the extended position to the retracted position, by displacement of the longitudinal sledge towards the circular bolt. The closing plate ensures that a rotation of the circular bolt from the extended position to the retracted position cannot be driven externally. A mechanism of this kind is advantageous; as otherwise, the lock could be opened by inserting a flat object, for instance a credit card, between the door leaf and the doorframe, thereby turning back the circular bolt.

In yet another preferred embodiment of the invention, an interlocking plate is provided, which is movable from an unlocked position to a locked position, by rotation of the circular bolt from the extended position to the retracted position and that rotation of the circular bolt from the retracted position to the extended position can be blocked by the interlocking plate in the locked position.

This is advantageous in that the circular bolt, when rotated into the retracted position, is held in this position. Such a mechanism advantageously allows a flush design of the lock when the door is open.

In yet another preferred embodiment of the invention, a blocking unit is provided between the front plate of the housing and the interlocking plate, by means of which the interlocking plate can be blocked in the locked position. The blocking unit ensures that the interlocking plate, which has been displaced to the locked position, is held in this position. By means of such a mechanism, the sliding door can be displaced without any risk of the interlocking plate moving back from the locked position to the unlocked position.

In yet another embodiment of the invention, the interlocking plate, which is blocked in the locked position by the blocking unit, can be released by displacing the blocking unit towards the front plate and rotation of the circular bolt from the retracted position to the extended position can be triggered by releasing the interlocking plate. Consequently, the inventive lock is advantageously self-locking and extension of the circular bolt is triggered merely by displacing the blocking unit.

In another preferred embodiment of the invention, the blocking unit comprises a permanent magnet, the position of which is advantageously adjustable within the blocking unit, wherein the displacement of the blocking unit and release of the interlocking plate can be effected, i.e. is effectable by a counter-magnet. Thus, the inventive lock is magnetically triggerable. The advantage of a magnetic actuating mechanism lies in the fact that it does not require any additional complicated mechanism on the side of the doorframe or strike plate. The possibility of being able to adjust the position of the magnet within the blocking unit implies that the amount of force between the magnet in the lock and the counter-magnet in the strike plate is easily adjustable by the distance between the two magnets.

The objects of the invention are furthermore also achieved by a fitting for operating an inventive lock, comprising a housing, a handle rotatable in a bearing connected to the housing and a slider, which provides means for attaching a connecting element for connection to the lock and which connects the fitting to the lock, wherein displacement of the slider and the attached connecting element relative to the housing can be effected by turning the handle, and wherein a locking mechanism, comprising an actuator designed for operation by the user and a locking element, is provided, wherein the locking element can be brought into a blocking position for displacement of the slider by displacing the actuating element in a direction parallel to the connecting element.

Such a configuration enables the inventive fitting to allow operation of an inventive lock. In addition, since the connecting element can be attached on both sides of the slider, rotating the flap can apply an impact force or tractive force. In this manner, the inventive fitting is able to operate an inventive lock, regardless of whether the lock is mounted frontally or laterally. Furthermore, an inventive fitting can be locked owing to the locking mechanism.

In a first preferred embodiment of the inventive fitting, the handle comprises a tab arranged perpendicular to the axis of the handle, with displacement of the slider as well as of the connecting element attached to the slider relative to the housing being effected by turning the tab around the axis of the handle. Owing to this advantageous mechanism, rotation of the handle around a vertical axis can be translated into a horizontal displacement of the slider and of the connecting element attached to the slider and the inventive fitting can assume the form of a functional shell handle. In addition, since the connecting element can be attached on both sides of the slider, rotating the flap can apply an impact force or tractive force.

In a variant of the first preferred embodiment of the inventive fitting, a spring is provided between the slider and the housing, by means of which, following rotation of the handle and displacement of the slider, automatic return of the handle and of the slider to their original position can be effected. This ensures that the flap of the inventive fitting always returns to its original position.

In a second preferred embodiment of the inventive fitting, the fitting comprises a turntable having a hole for attaching a connecting element. Displacement of the connecting element attached to the turntable relative to the housing can be effected by the rotation of the handle. In this preferred embodiment, a rotation of the handle around a horizontal axis can initiate operation of the lock. In addition, since the connecting element can be attached on both sides of the turntable, rotating the handle can generate an impact force or tractive force in order to operate an inventive lock.

The objects of the invention are also achieved by a strike plate for locking a lock, comprising a housing with a front plate that has a longitudinal axis, an opening for receiving a circular bolt of an inventive lock and a magnet held in a plastic socket, which magnet is eccentrically incorporated in the plastic socket, with the position of the magnet relative to the front plate longitudinal axis being adjustable with a rotation of the plastic socket.

By adjusting the position of the magnet relative to the longitudinal axis of the strike plate, the moment at which the lock is locked can be set. The ability to adjust the position of the magnet in the strike plate guarantees optimum triggering of an inventive lock, regardless of whether the lock is mounted laterally or frontally. This is particularly advantageous in the case of a laterally installed lock, in which it is essential to ensure that the lock bolt does not lock in front of the opening of the strike plate. In the case of a frontally mounted lock, the position of the magnet can be adapted so that the circular bolt can be optimally inserted into the opening of the strike plate.

In a preferred embodiment of the inventive strike plate, a vertical strike plate unit and a horizontal strike plate unit are provided, with which the shape and size of the opening of the inventive strike plate can be adapted to the circular bolt of a lock. This allows achieving of optimum locking of the lock.

In a further preferred embodiment of the inventive strike plate, the plastic socket comprises supports, by means of which a rotation of the plastic socket in the housing can be blocked. This ensures that the relative position of the magnet relative to the housing cannot change automatically over time.

The objects of the invention are furthermore also achieved by a closing device for sliding doors, comprising an inventive lock, an inventive fitting and a connecting element that connects the lock to the fitting, with the closing device allowing lateral and frontal locking of a sliding door. This ensures a high level of installation versatility of the closing device.

In a preferred embodiment of the invention, a laterally mounted lock can be operated by an impact or tractive force exerted by a connecting element. This increases the installation versatility of the inventive closing device even further.

In another preferred embodiment of the invention, the impact or tractive force required to operate the lock can be generated by rotating a handle of the fitting. Consequently, the fitting and lock can be spatially separated and solely connected by the connecting element.

In another preferred embodiment of the invention, the fitting comprises a locking mechanism and the locking mechanism cannot be operated when the circular bolt of the lock is in its retracted position.

In another preferred embodiment of the invention, the closing device comprises an inventive strike plate. This ensures optimum locking of the closing device and in particular of the inventive lock.

In a further preferred embodiment of the invention, the lock is self-locking and advantageously magnetically triggerable. Consequently, the lock may have a flush design that is particularly advantageous for aesthetic and safety reasons when the door is open. The possibility of providing for a self-locking and magnetically triggerable lock allows creating the triggering mechanism on the side of the doorframe and the strike plate with a simple construction.

The objects of the invention are furthermore also achieved by a sliding door system that comprises an inventive closing device. Consequently, sliding door systems can be employed where a frontal locking or a lateral locking is desired.

Further details of the invention will be apparent from the detailed description of the preferred embodiments of the invention illustrated in the attached drawings. The description also shows further advantages of the present invention as well as suggestions and proposals as to how the subject matter of the invention could be amended or further developed within the scope of the claims.

### BRIEF DESCRIPTION OF THE DRAWINGS

FIG. 1a shows a perspective diagrammatic representation from the side of the interlocking plate of an inventive lock with the bolt of the lock extended;

FIG. 1b shows a perspective diagrammatic representation from the side of the closing plate of an inventive lock with the bolt extended;

FIG. 1c shows a perspective diagrammatic sectional view from the side of the interlocking plate of an inventive lock with the bolt extended;

FIG. 1d shows a diagrammatic lateral sectional view from the side of the interlocking plate of an inventive lock with the bolt extended;

FIG. 2a shows a perspective diagrammatic representation from the side of the interlocking plate of an inventive lock with the bolt retracted and with a longitudinal sledge;

FIG. 2b shows a perspective diagrammatic representation from the side of the closing plate of an inventive lock with the bolt retracted and with the longitudinal sledge;

FIG. 2c shows a perspective diagrammatic sectional view from the side of the interlocking plate of an inventive lock with the bolt retracted and with the longitudinal sledge;

FIG. 2d shows a diagrammatic lateral sectional view from the side of the interlocking plate of an inventive lock with the bolt retracted and with the longitudinal sledge;

FIG. 3a shows a perspective diagrammatic representation from the side of the interlocking plate of an inventive lock with the bolt retracted and the longitudinal sledge in extended position;

FIG. 3b shows a perspective diagrammatic representation from the side of the closing plate of an inventive lock with the bolt retracted and the longitudinal sledge in extended position;

FIG. 3c shows a perspective diagrammatic sectional view from the side of the interlocking plate of an inventive lock with the bolt retracted and the longitudinal sledge in extended position;

FIG. 3d shows a diagrammatic lateral sectional view from the side of the interlocking plate of an inventive lock with the bolt retracted and the longitudinal sledge in extended position;

FIG. 4a shows a perspective diagrammatic representation of a closing device for inventive sliding doors with a first embodiment of an inventive fitting in the form of a shell handle and a lock laterally installed and a lock frontally installed:

FIG. 4b shows the closing device of FIG. 4a, but such that a front plate of the shell handle is concealed;

FIG. 4c shows a perspective diagrammatic representation of a slider and a flap of the inventive shell handle;

FIG. 4d shows the closing device of FIG. 4a, but such that a housing of the shell handle is concealed and wherein the flap has been rotated;

FIG. 5a shows a diagrammatic lateral sectional view of the locking mechanism of an inventive shell handle in the unlocked position;

FIG. 5b shows a diagrammatic lateral sectional view of the locking mechanism of an inventive shell handle in the locked position;

FIG. 6a shows a perspective diagrammatic representation of an inventive strike plate;

FIG. 6b shows a perspective diagrammatic sectional view of an inventive strike plate;

FIG. 6c shows a perspective diagrammatic representation of the housing of an inventive strike plate;

FIG. 7 shows a perspective diagrammatic representation of a second embodiment of an inventive fitting;

FIG. 8 shows a perspective diagrammatic representation of a preferred embodiment of an inventive sliding door system;

FIG. 9 shows a diagrammatic sectional view of the locking mechanism according to a second embodiment of an inventive fitting in the form of a shell handle in the unlocked position; and

FIG. 10 shows a diagrammatic lateral sectional view of the locking mechanism according to a second embodiment of an inventive fitting in the form of a shell handle in the locked position.

### PREFERRED EMBODIMENTS OF THE INVENTION

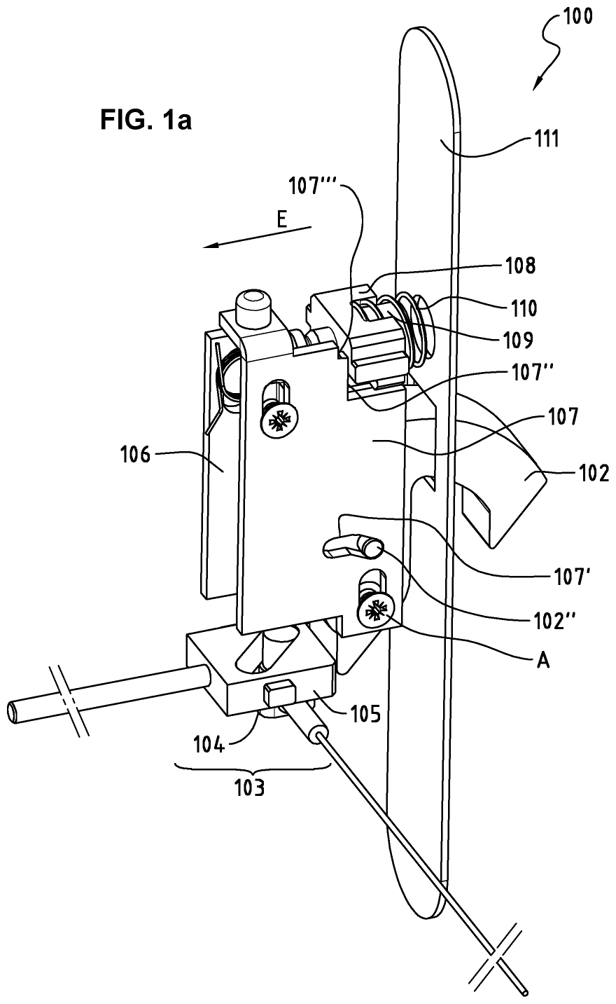

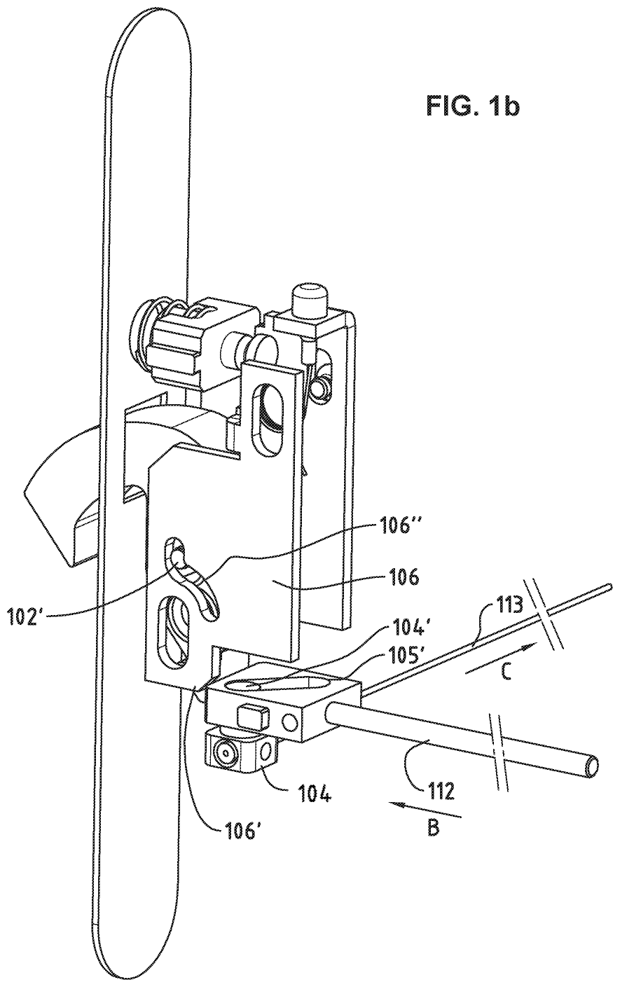

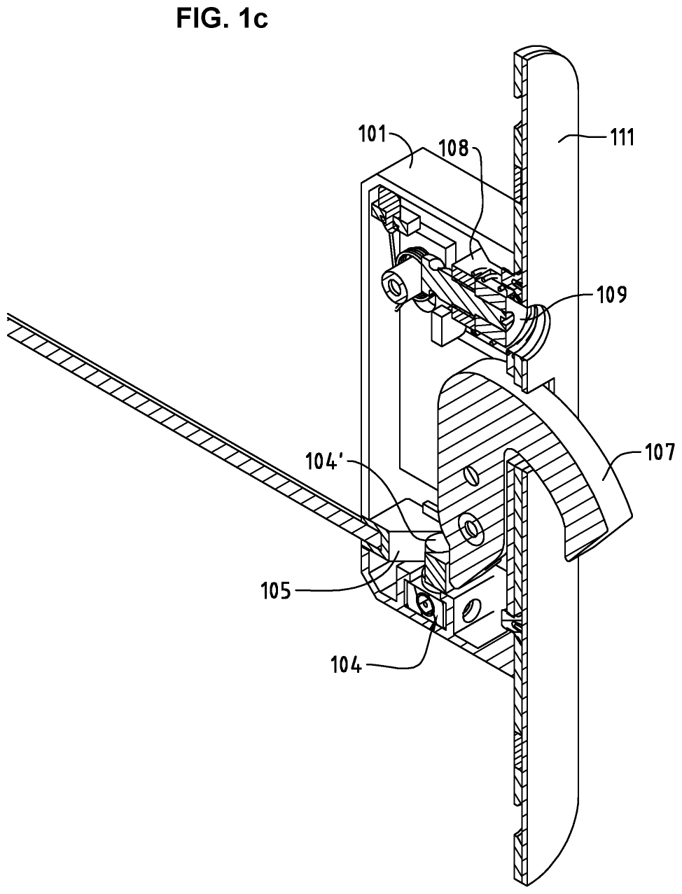

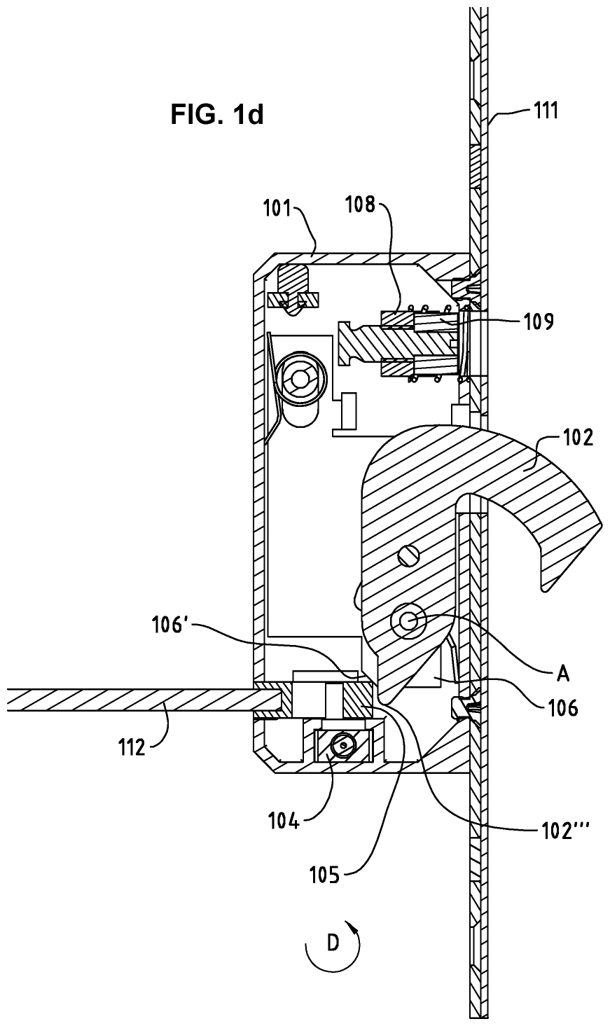

FIG. 1a shows a perspective diagrammatic representation of an inventive lock 100 in its closed position, which among other aspects, features a circular bolt 102, an interlocking plate 107, a closing plate 106, a sledge system 103 and a front plate 111, viewed from the side of the interlocking plate 107.

FIG. 1b shows a perspective diagrammatic representation of an inventive lock 100 in its closed position, viewed from the side of the closing plate 106. In FIG. 1a and FIG. 1b, the housing 101 of the lock is concealed. The housing 101 of the lock is illustrated in FIG. 1c and FIG. 1d.

FIG. 1a and FIG. 1b show a transverse sledge 104 and a longitudinal sledge 105 in addition to the circular bolt 102, which is rotatable around an axis A. The transverse and longitudinal sledges 104, 105 jointly form the sledge system 103. A portion of the circular bolt 102 protrudes, in its extended position, from the plate 111, which forms the front of the housing 101.

As can be seen in FIG. 1b, the circular bolt 102 has a protrusion 102′ on the side of the closing plate 106. The closing plate 106, for its part, has a groove 106□, comprising a vertical section and a curved section. When the lock 100 is in the closed position, the protrusion 102′ of the circular bolt 102 lies in the vertical section of the groove 106□ of the closing plate 106, thereby preventing a free rotation of the circular bolt 102. The closing plate 106 thus constitutes a safety element that prohibits opening of the lock 100 from outside the housing 101.

In the extended position of the circular bolt 102, the longitudinal sledge 105 adjoins an oblique bottom edge 106′ of the closing plate 106, as illustrated in FIG. 1d. Displacing the longitudinal sledge 105 towards the plate 111 first causes a vertical displacement of the closing plate 106 and consequently of the groove 106□ relative to the protrusion 102′, which, following this displacement, is located at the top end of the curved section of the groove 106□. In this position, the protrusion 102′ no longer prevents the circular bolt 102□ from rotating about axis A.

The displacement of the longitudinal sledge 105 can be effected either by an impact force in direction B, by means of a rigid rod for example, applied directly to the longitudinal sledge 105, or by a tractive force in direction C, by means for example of a rod or a cable, applied to the transverse sledge 104. The displacement of the transverse sledge 104 in direction C is converted into a movement of the longitudinal sledge 105 in direction B owing to a projection 104′ of the transverse sledge 104 and a diagonally aligned groove 105′ in the longitudinal sledge 105. It is therefore possible to operate and open the lock 100 either with an impact force or with a tractive force applied to the sledge system 103. It should be noted that the pulling direction C can be easily changed by a 180° rotation of the longitudinal sledge 105.

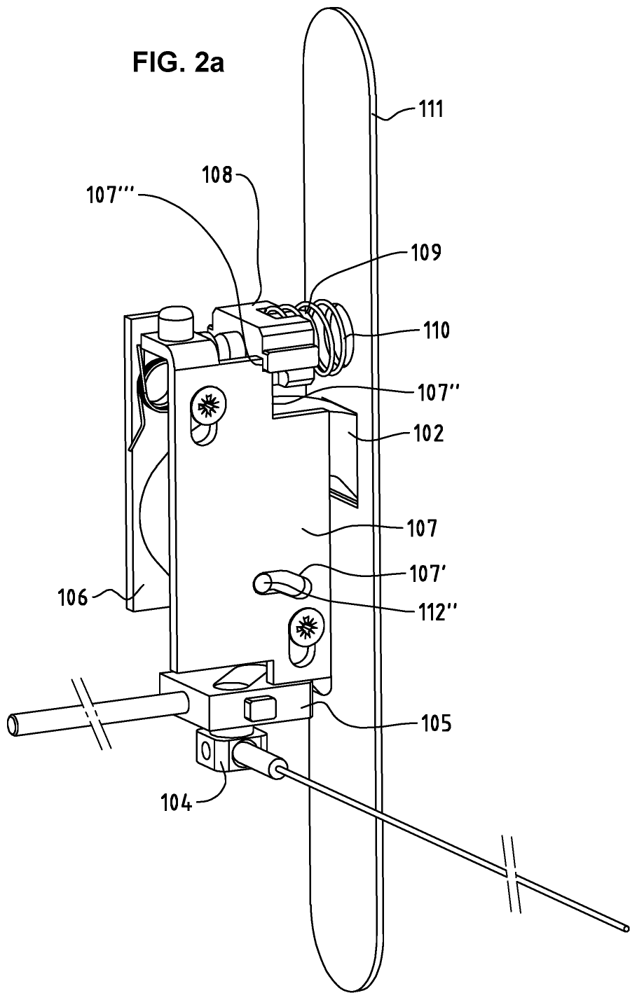

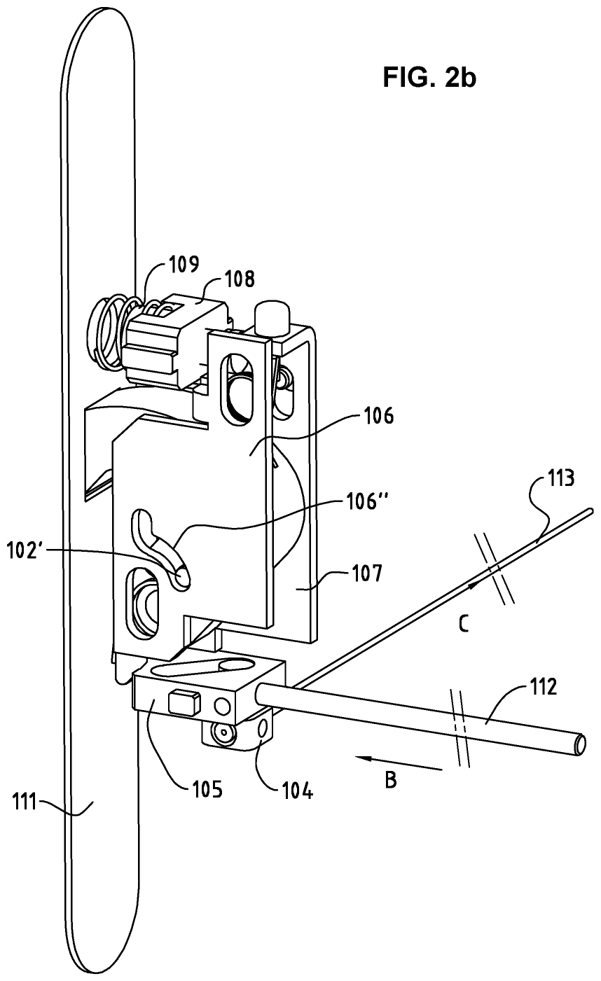

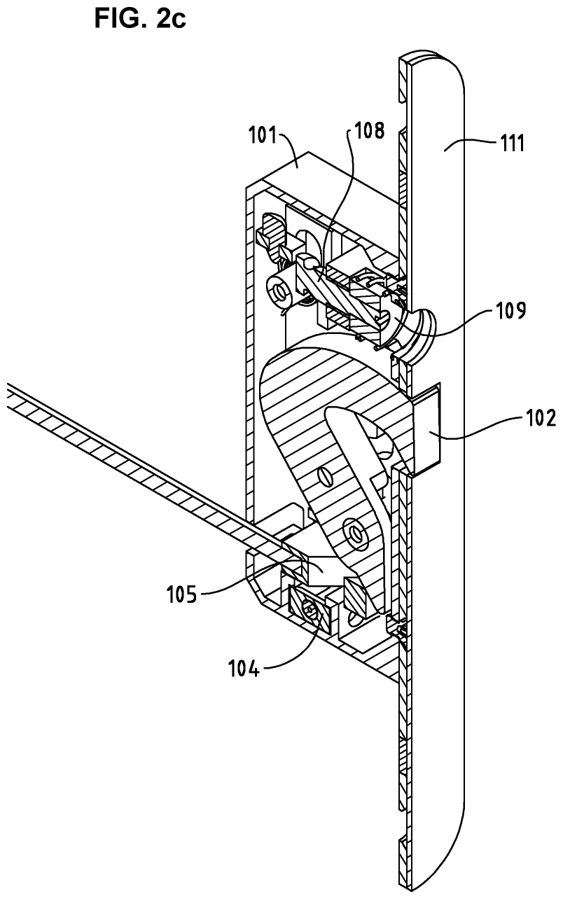

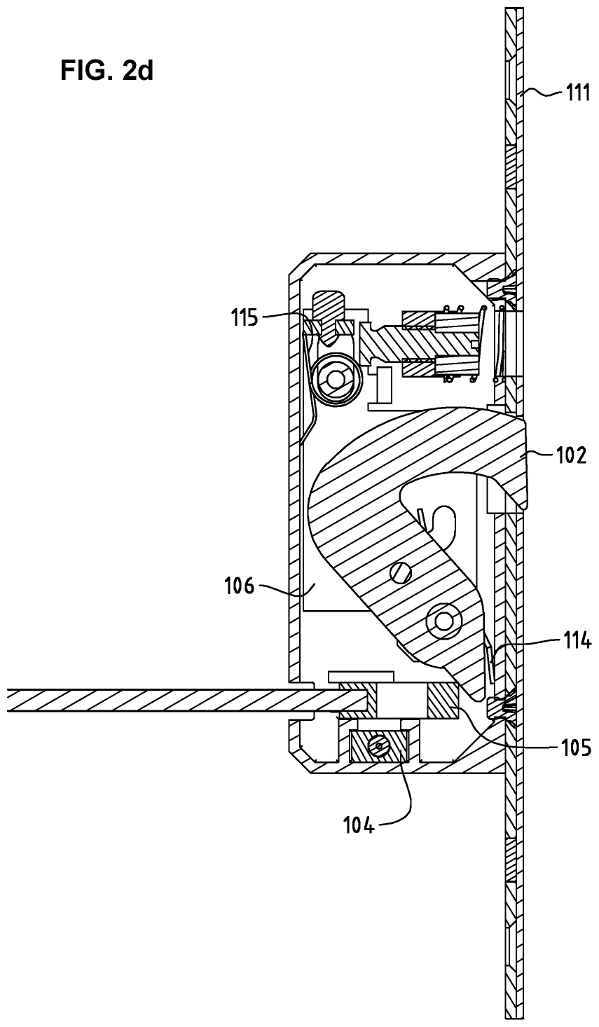

After the closing plate 106 has been lifted by means of the longitudinal sledge 105, the longitudinal sledge 105 pushes against a bottom edge 102□ of the circular bolt 102 and rotates the circular bolt 102 around axis A and in direction D until the position illustrated in FIGS. 2a-2c is reached. As can be seen in FIG. 1a, the circular bolt 102 also has a protrusion 102□ on the side of the interlocking plate 107. The interlocking plate 107 has a groove 107′ with a horizontal and an oblique section. The rotation of the circular bolt 102 lowers the interlocking plate 107, owing to the protrusion 102□ and the shape of the groove 107′ in the interlocking plate 107.

The inventive lock 100 also comprises a blocking unit 108, which carries a magnet 109. The blocking unit 108 is required for unlocking the inventive lock 100. The functional principle of the blocking unit 108 is explained below.

When the lock 100 is in the closed position, the blocking unit 108, which comprises the magnet 109, abuts against an edge 107□ of the interlocking plate 107, as is apparent from FIGS. 1a-1d.

Through lowering of the interlocking plate 107, the blocking unit 108 is released and under the action of the spring force of a spring 110, arranged between the blocking unit 108 and the front plate 111, is pushed away in direction E, until it abuts against an edge 107□ of the interlocking plate 107. The blocking unit 108 in this position prevents rising of the interlocking plate 107 and thus rotating of the circular bolt 102 back into the extended position.

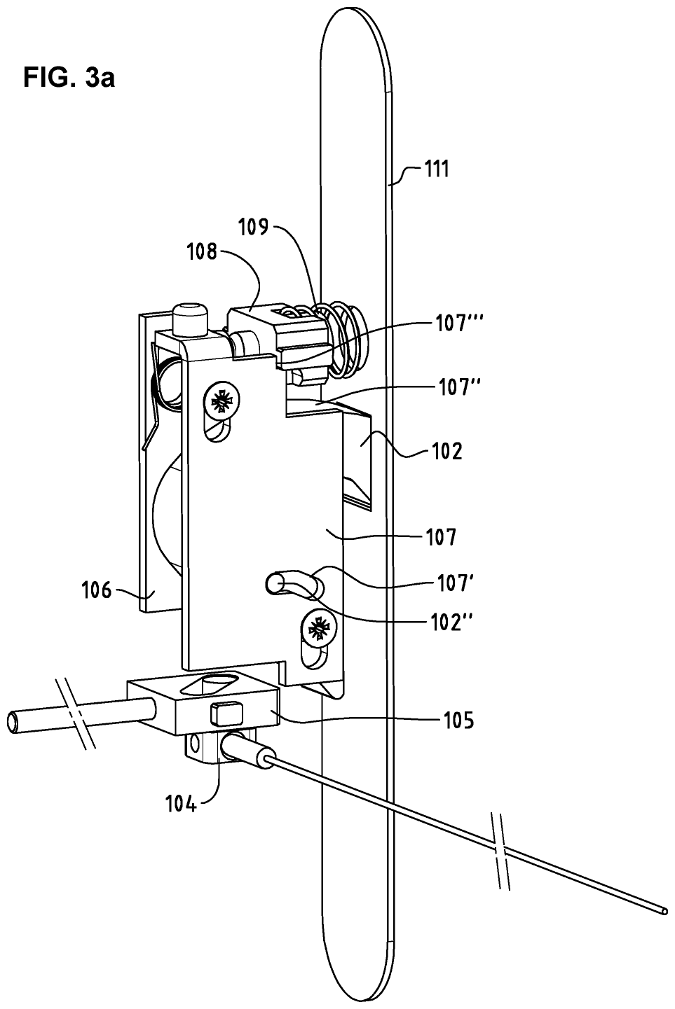

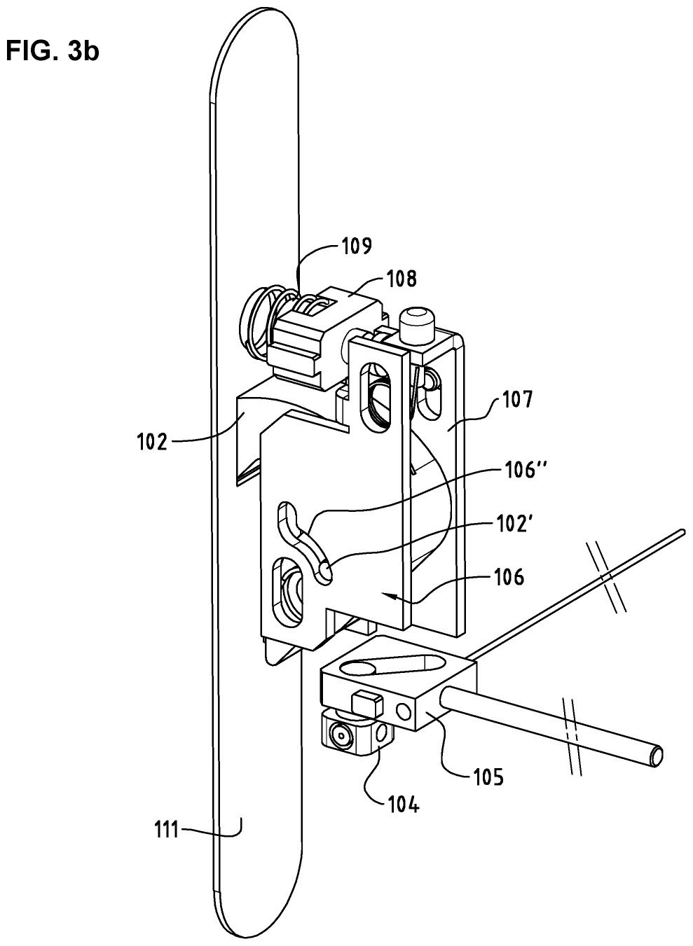

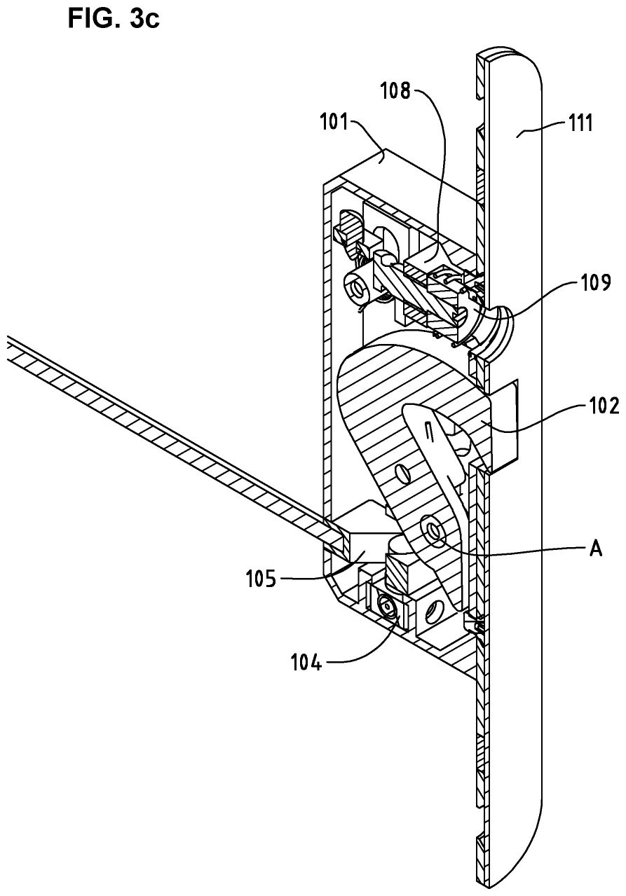

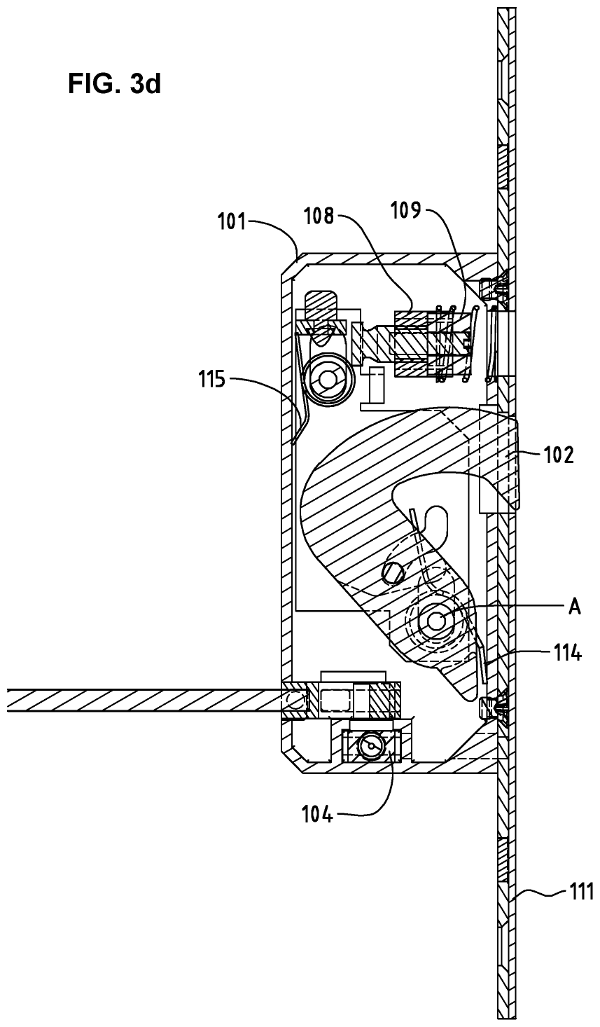

The locking of the interlocking plate 107 by means of the blocking unit 108 allows the longitudinal sledge 105 to return to its original position without rotation of the circular bolt 102, as illustrated in FIGS. 3a to 3d. The door in which the lock 100 is installed can therefore be moved with the circular bolt in the retracted position, without the need to exert force on the sledge system 103.

The interlocking plate 107 must be released again in order to lock the lock 100. In this preferred embodiment of the invention, this is achieved by the action of a counter-magnet 405, which attracts the magnet 109 and compresses the spring 110. This counter-magnet 405 can be installed for example in the doorframe or in the strike plate 400. By bringing the counter-magnet 405 closer to the magnet 109 of the lock 100, the magnet 109 of the lock 100 can be drawn towards the front plate 111. As a result, the blocking unit 108 is also moved towards the front plate 111 and the interlocking plate 107 is released.

When the interlocking plate 107 is released, it can be raised again. A circular bolt spring 114, which is arranged between the front plate 111 and the circular bolt 102, causes the circular bolt 102 to rotate around axis A back to the extended position. By the action of a closing plate spring 115, the closing plate 106 also returns to the original position (FIGS. 1a-1d). Consequently, the lock 100 is advantageously self-locking and the extension of the circular bolt 102 is merely triggered by displacing the blocking unit 108.

Preferably, the position of the magnet 109 in the blocking unit 108 can be adjusted. This makes it easy to adjust the force of attraction between the two magnets 109, 405. In a preferred embodiment of the invention, the magnet 109 is connected to a threaded rod 108′, which is screwed into the blocking unit 108, until the desired position of the magnet 109 is achieved.

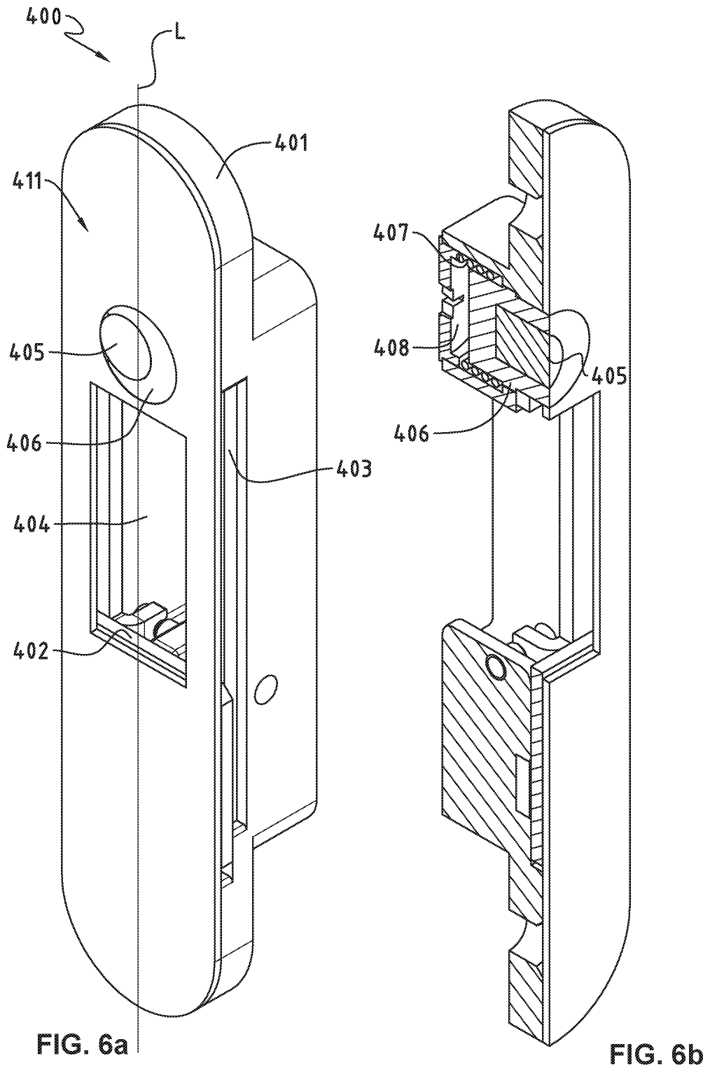

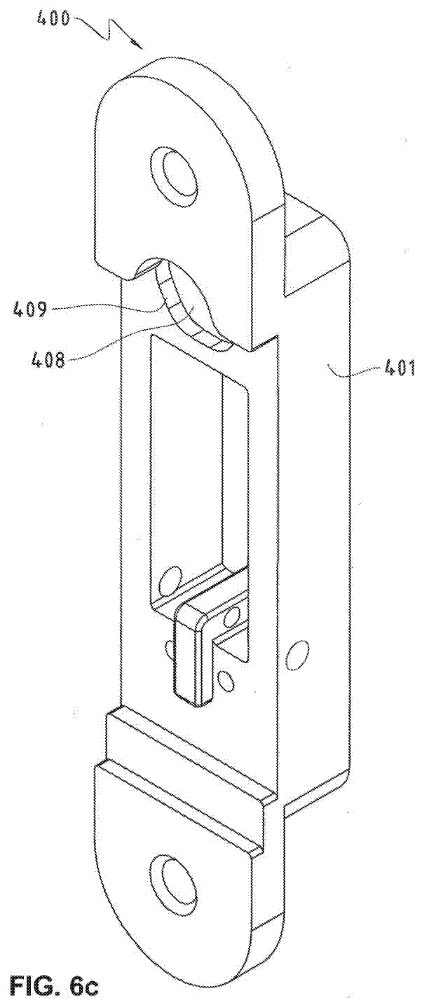

FIG. 6a shows a preferred embodiment of an inventive strike plate 400. The strike plate 400 comprises a housing 401, a vertical strike plate unit 402, which can be displaced vertically and a horizontal strike plate unit 403, which can be displaced horizontally. By displacing the vertical strike plate unit 402 and the horizontal strike plate unit 403, the size and position of an opening 404 in the strike plate 400 can be adapted to the position and size of the circular bolt 102 of the inventive lock 100, in order to ensure optimum locking of a door. In the inventive strike plate 400, a counter-magnet 405 is installed in a plastic socket 406 and preferably held eccentrically. The plastic socket 406 is held in the housing 401 by means of a spring 407. This allows adaptation of the eccentric position of the counter-magnet 405 for right or left lateral installation of the lock 100 or for frontal installation of the lock 100. Adjustment of the position of the counter-magnet 405 is particularly important for lateral installation to ensure that the circular bolt 102 does not in any event lock in front of the opening 404. In the event of frontal installation of the lock 100, the position of the counter-magnet 405 once again influences the point in time of locking in the lock 100, which can improve convenience of use.

In order to ensure that the position of the magnet 405 does not change automatically over time, the plastic socket 406 comprises several supports 410 and a cavity 408 with locking surfaces 409. When the plastic socket 406 is flush with the front plate 411 of the housing 401, the supports 410 rest on the locking surfaces 409 and the plastic socket is unable to rotate. In order to be able to readjust the position of the magnet 405, the plastic socket 406 must be pressed against the spring 407 into the cavity 408 such that the supports 410 no longer rest on the surfaces 409. The plastic socket 406, after being rotated, can be released again.

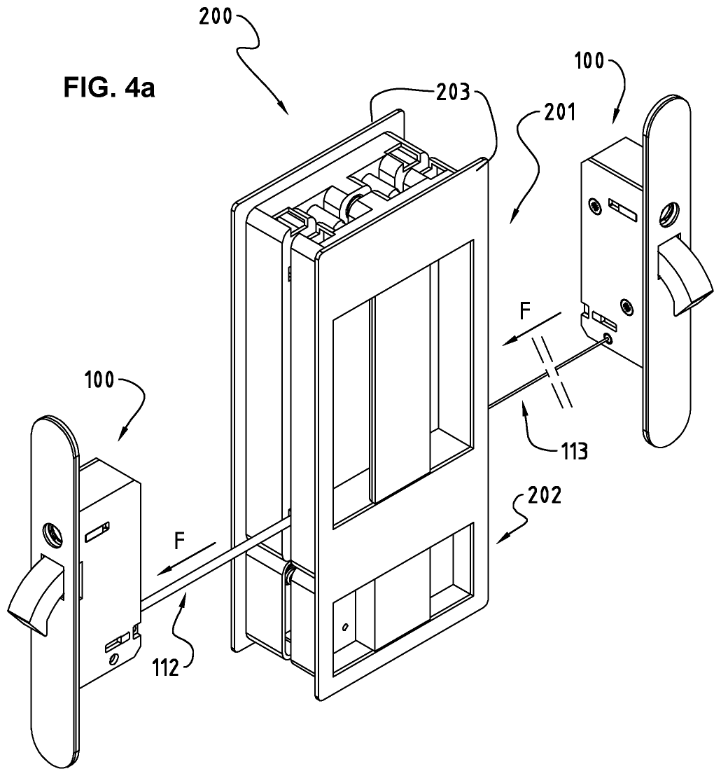

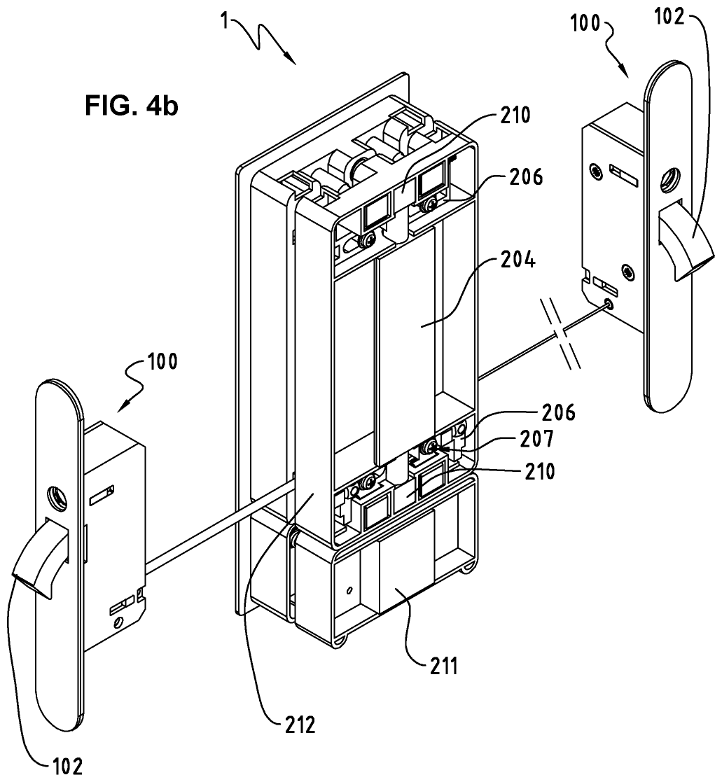

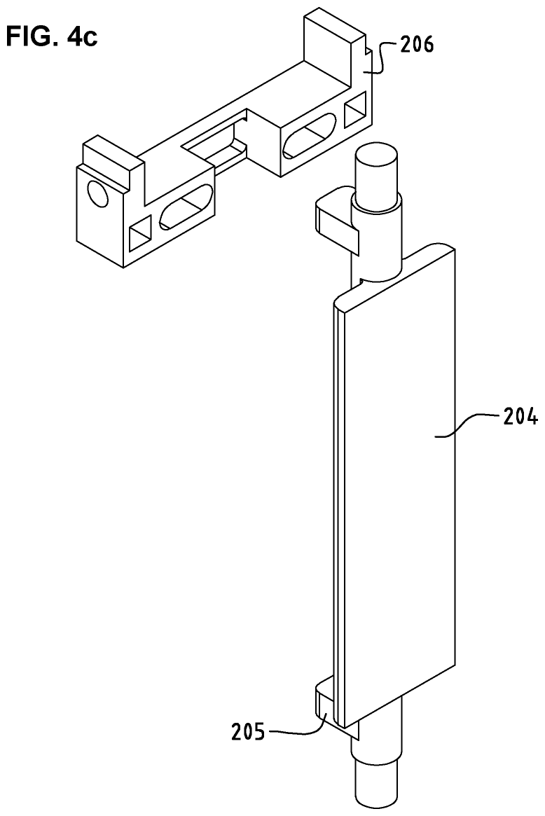

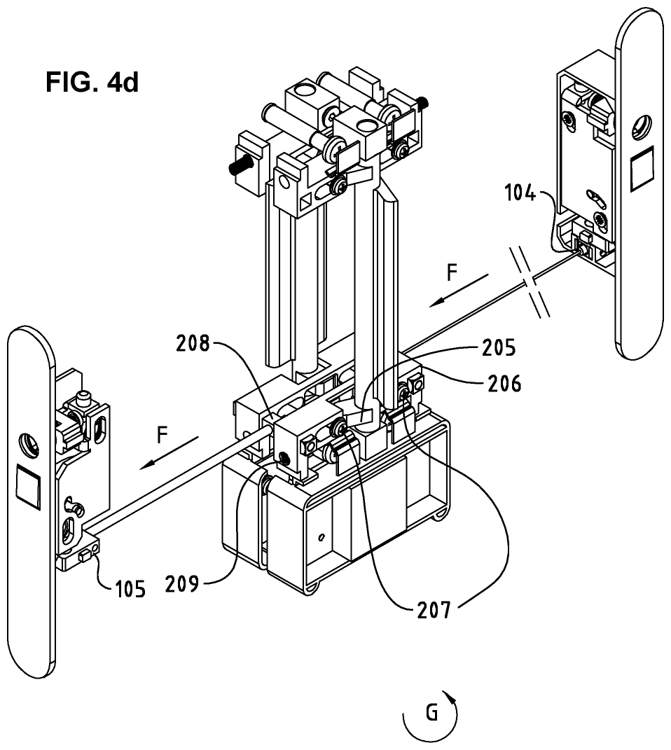

As explained above, the inventive lock 100 can be operated by either an impact force or a tractive force. This makes it possible, as shown in FIG. 4a, to install the lock 100 laterally and frontally in a door, preferably in a sliding door.

A first embodiment of a fitting 200 for the lock 100 is shown in FIGS. 4a-4d. The inventive shell handle 200 allows operation of the lock 100 regardless of whether installed laterally or frontally. The frontally mounted lock 100, on the left in FIGS. 4a, 4b and 4d, is connected to the shell handle 200 by a rigid rod 112. The laterally mounted lock 100, on the right in these figures, is connected to the shell handle 200 by a cable 113 and if necessary a rod. The rod 112 is fastened to the longitudinal sledge 105 or the transverse sledge 104 and the cable 113 to the transverse sledge 104. The shell handle 200 consists of a functional component 201 for operating the lock 100 and of a locking mechanism 202.

FIG. 4b, in which the front plate 203 has been concealed, shows the inside of the shell handle 200. Visible, among other elements, is the handle 204, which assumes the form of a flap in this preferred embodiment, and the slider 206. The flap 204 is rotatably mounted in the bearings 210, which are firmly connected to the housing 212 of the shell handle 200. FIG. 4c shows the flap 204 with the tab 205 and the slider 206 in closer detail.

On rotating the flap 204, the slider 206 is displaced under the action of the tab 205 in direction F. The slider 206 is retained horizontally displaceable by means of screws 207, which pass through the grooves 206′ of the slider 206. Since the rod 112 and/or the cable 113 are connected to the slider 206 by attachment means 208, such as for example threaded pins, the rod 112 and the cable 113 also move in direction F (see FIG. 4a) and operate the lock 100. On displacement of the slider 206, the spring 209, which is installed between the housing 212 and the slider 206, is compressed. When the flap 204 is released, the spring 209 pushes the slider 206 back into the original position and turns back the flap 204. The symmetrical construction of the shell handle 200 means that the frontally and laterally mounted locks 100 can be exchanged. In such a case, the locks are operated by rotating the flap 204 in the opposite direction to G.

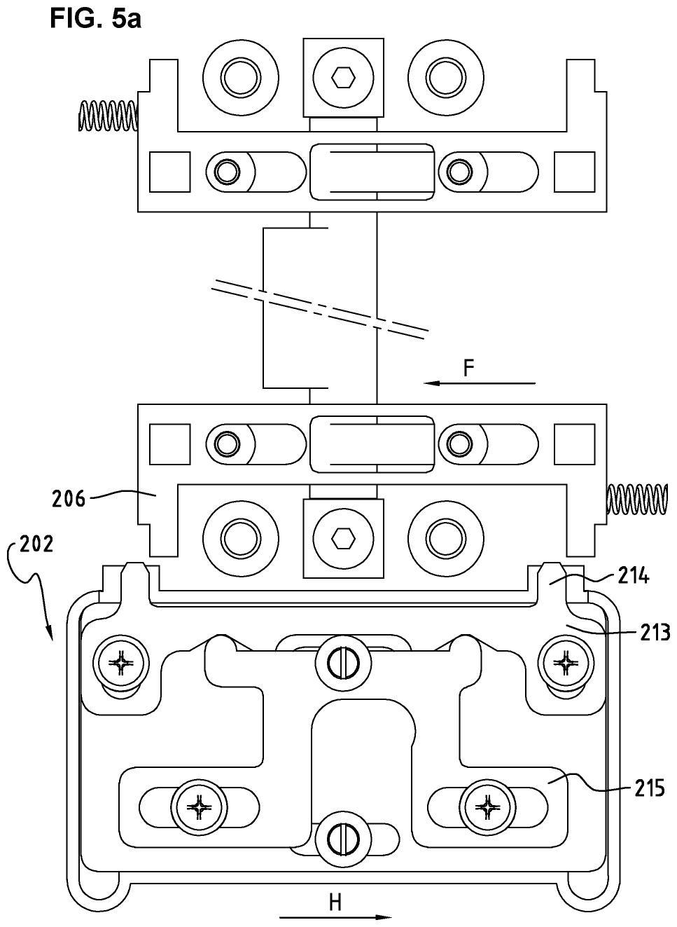

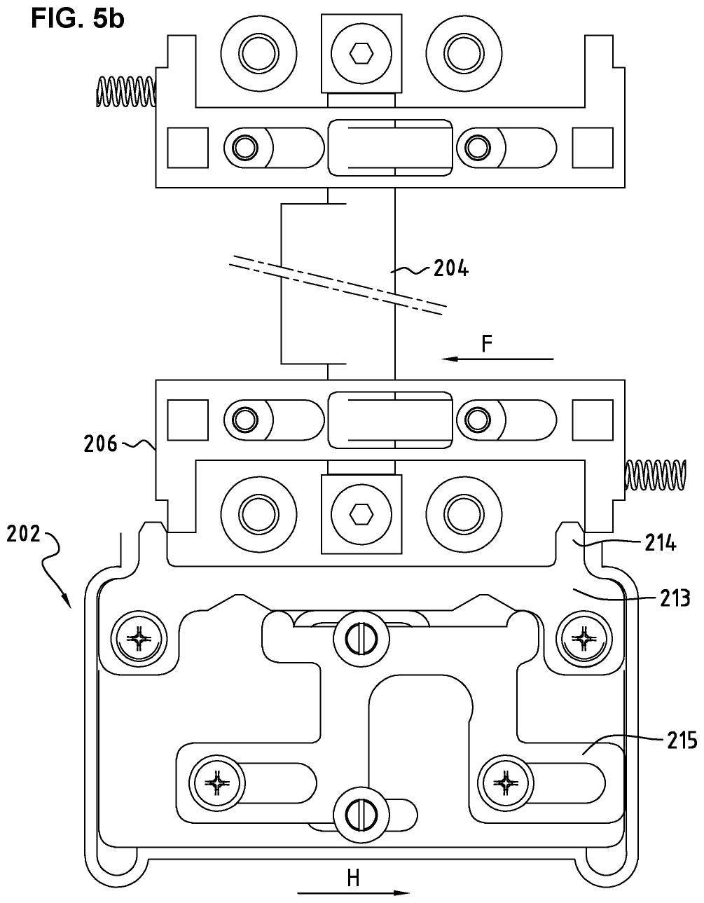

The locking mechanism 202 is described in greater detail based on FIGS. 5a and 5b. The mechanism 202 consists of three parts, i.e. an actuator 211 (FIGS. 4a and 4b), a slide element 215 and a locking element 213 with lugs 214.

FIG. 5a shows the mechanism 202 in the unlocked position, in which the lug 214 of the locking element 213 is lower than the bottommost edge of the slides 206. By displacing the actuator 211, which is connected to the slide element 215, in direction H, the locking element 213 is raised. As shown in FIG. 5b, after displacement of the actuator 211, the lug 214 of the locking element 213 is once again higher than the bottommost edge of the slides 206, thereby preventing displacement of the slider 206 in direction F. The locks 100 cannot be operated in this position. Unlocking is performed by pushing back the slide element 211 and lowering the locking element 213.

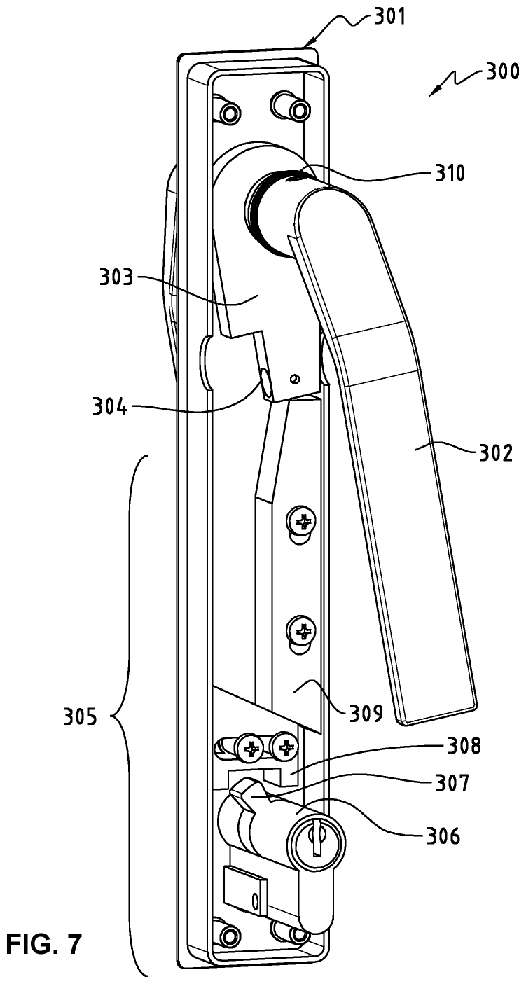

A second embodiment of a fitting for the closing device 1 is shown in FIG. 7. The inventive fitting 300 allows operation of the lock 100 regardless of whether installed laterally or frontally. The fitting 300 comprises a housing 301 and a handle 302, which is rotatably mounted in a bearing 310. In this figure, the front plate of the housing 301 is concealed. A slider 303, which assumes the form of a turntable in this preferred embodiment, is incorporated in the housing 301, integral with the handle 302 and therefore rotates with the handle 302. A rod 112 or a cable 113 of the closing device 1 can be attached in a hole 304 in the turntable 303. The connecting element 112, 113 can be mounted on both sides of the turntable 303 and consequently on both sides of the housing. Rotating the handle 302 causes a displacement of the rod 112 or of the cable 113, thereby operating the lock 100.

The fitting 300 also comprises a locking mechanism 305. The locking mechanism 305 features, in this embodiment, a lock cylinder 306 with a protrusion 307. The rotation of the cylinder 306 drives a lateral displacement of a first locking plate 308 and thus a vertical displacement of a second locking plate 309. In the locked position, the second locking plate 309 abuts against the bottom edge of the turntable 303, thereby prohibiting a rotation of the turntable 303.

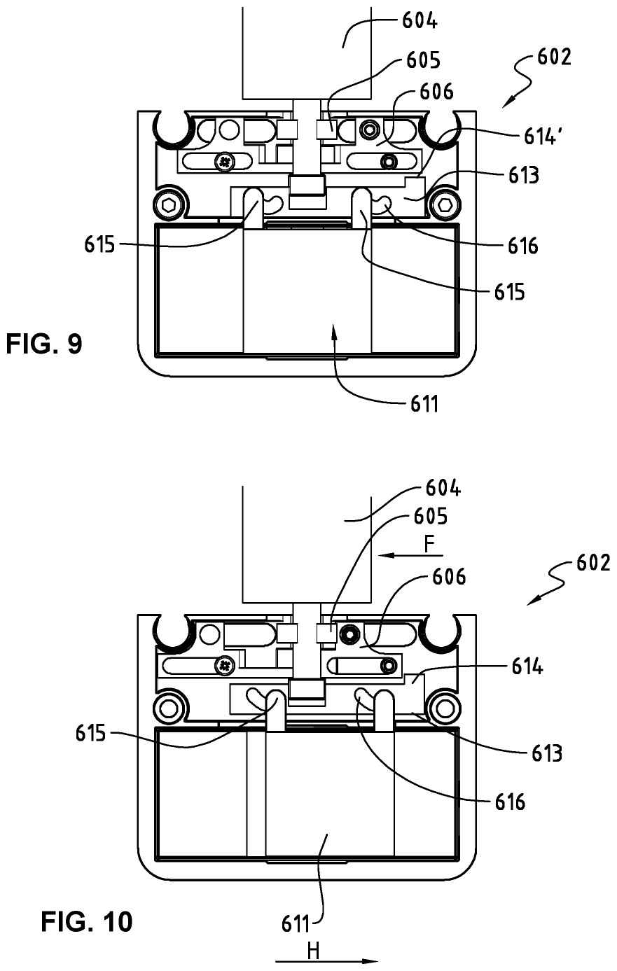

A second embodiment of a fitting for operating a lock 100 is shown in FIGS. 9 and 10. The shell handle 600 according to this embodiment of the invention is similar to the shell handle 200 in FIGS. 4a, 4b, 4c, 4d, 5a and 5b and likewise allows operation of the lock 100 regardless of whether the lock 100 is installed laterally or frontally. The difference between the fitting 200 and the fitting 600 lies solely in the locking mechanism.

The elements of the locking mechanism 602 of the fitting 600 are illustrated in greater detail in FIGS. 9 and 10. The other elements of the fitting 600 correspond to those of the fitting 200 and are therefore not described again here. The mechanism 602 consists of three elements, i.e. an actuator 611, which is connected to the slide elements 615 and a locking element 613 with the lug 614.

FIG. 9 shows the mechanism 602 in the unlocked position, in which the lug 614 of the locking element 613 is lower than the bottommost edge of the slider 606. The position of the slider 606 in FIG. 9 represents the situation in which the circular bolt 102 of the lock 100 is retracted; i.e., when the lock 100 is unlocked. As can be seen in FIG. 9, the mechanism 602 is designed such that it is impossible to lock the fitting in this position, since the locking element 613 is blocked by the slider 606. It is namely advantageous that the fitting cannot be locked when the circular bolt is retracted. If it were possible to lock the fitting, this would render self-locking of the lock impossible.

If the circular bolt 102 of the lock 100 is now in its extended position, the slider 606 is displaced in direction F by means of the connecting element 112 (not illustrated here). In the position of the slider 606 represented in FIG. 10, the fitting 600 can now be locked. By displacing the actuator 611, which is connected to the slide element 615, in direction H, the locking element 613 is raised owing to the asymmetrical shape of the guide holes 616. As shown in FIG. 10, after displacement of the actuator 611, the lug 614 of the locking element 613 is once again higher than the bottommost edge of the slider 606, thereby preventing displacement of the slider 606 in direction H. The fitting 600 cannot be operated in this position and the lock 100 cannot be unlocked. Unlocking of the fitting 600 is performed by pushing back the actuator 611 and lowering the locking element 613.

It is important to note that the fitting 600 is designed in such a way that the lock 100 can be positioned on the left or right (as in FIG. 9). In fact, the locking element 613 can be simply rotated so that the lug 614 in this illustration is on the left.

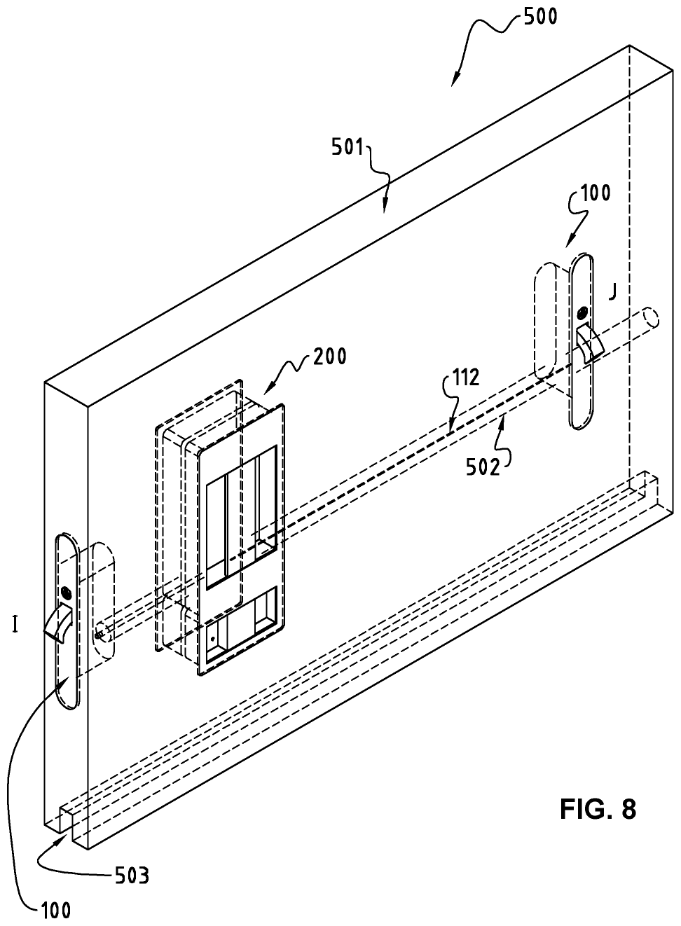

FIG. 8 shows a preferred embodiment of an inventive sliding door system 500. The sliding door system 500 comprises an inventive lock 100 that can be installed frontally (position I) or laterally (position J) in a sliding door 501. The sliding door system 500 also comprises a fitting 200 for operating the lock 100. In the present embodiment of the sliding door system 500, the fitting 200 assumes the form of an inventive shell handle 200. The fitting 200 and locks 100 are connected by connecting elements 112, 113, which are located in a bore 502 in the door 501. The door 501 also has a rail 503 for movement of the door 501 against the doorframe (not illustrated here).

Finally, it should once again be pointed out that the embodiments described here by way of examples only represent possibilities for realisation of the invention and should not in any way be regarded as limitative. The person skilled in the art will understand that other implementations of the invention and further elements are possible without neglecting the essential characteristics of the invention.

### LIST OF REFERENCES

1 closing device
100 lock
101 lock housing
102 circular bolt
102′ protrusion of the circular bolt for interaction with the closing plate
102″ protrusion of the circular bolt for interaction with the interlocking plate
102″′ bottom edge of the circular bolt
103 sledge system
104 transverse sledge
104′ protrusion of the transverse sledge
105 longitudinal sledge
105′ groove on the longitudinal sledge
106 closing plate
106′ oblique bottom edge of the closing plate
106″ groove on the closing plate
107 interlocking plate
107′ groove on the interlocking plate
107″ first top edge of the interlocking plate
107″′ second top edge of the interlocking plate
108 blocking unit
109 permanent magnet
110 blocking unit spring
111 front plate of the lock
112 rod
113 cable
114 circular bolt spring
115 closing plate spring
200 fitting
201 functional component of the fitting
202 locking mechanism
203 front plate of the fitting
204 flap
205 tab
206 slider
206′ groove on the slider
207 screws
208 means for attaching the connecting element
209 spring
210 bearing
211 actuator
212 fitting housing
213 locking element
214 lug
215 slide element
300 fitting
301 housing
302 handle
303 turntable
304 hole in the turntable
305 locking mechanism
306 lock cylinder
307 protrusion of the lock cylinder
308 first locking plate
309 second locking plate
400 strike plate
401 housing
402 vertical strike plate unit
403 horizontal strike plate unit
404 opening
405 magnet
406 plastic socket
407 spring
408 cavity
409 locking surface
410 supports of the plastic socket
411 front plate
500 sliding door system
501 sliding door
502 bore
503 rail
600 fitting
602 locking mechanism
604 flap
606 slider
611 actuator
613 locking element
614 lug
615 slide elements
616 guide holes
A pivot axis of the circular bolt
B direction of impact on the sledge system
C direction of traction on the sledge system
D direction of rotation of the circular bolt when opening the lock
E direction of impact of the blocking unit
F operating direction
G direction of rotation of the flap
H direction of displacement of the slide element
I frontal position
J lateral position

1. Lock for sliding doors comprising a housing, a circular bolt, which is rotatable around a pivot axis from an extended position to a retracted position, and a sledge system, through which rotation of the circular bolt from the extended position to the retracted position is effectable, wherein
that the sledge system comprises a longitudinal sledge and a transverse sledge, which are coupled to one another and which are displaceable relative to one another, wherein a rotation of the circular bolt from the extended position to the retracted position is triggerable by a displacement of the longitudinal sledge in the direction of the circular bolt,
that the longitudinal sledge and the transverse sledge interact in such a way that the displacement of the longitudinal sledge in the direction of the circular bolt is effectable by a displacement of the transverse sledge in the perpendicular direction, and
that rotation of the circular bolt from the extended position to the retracted position is effectable either by an impact force exerted on the longitudinal sledge or by a tractive force exerted on the transverse sledge.

2. Lock according to claim 1, wherein a closing plate is provided, which is movable from a locked position, in which rotation of the circular bolt from the extended position to the retracted position is blocked, to an unlocked position, in which the circular bolt is rotatable from the extended position to the retracted position, by the displacement of the longitudinal sledge towards the circular bolt.

3. Lock according to claim 1, wherein an interlocking plate is provided, which is movable by the circular bolt, by the rotation of the circular bolt from the extended position to the retracted position, from an unlocked position to a locked position, and that rotation of the circular bolt from the retracted position to the extended position can be blocked by the interlocking plate in the locked position.

4. Lock according to claim 3, wherein a blocking unit is provided between the front plate of the housing and the interlocking plate, by means of which blocking unit the interlocking plate can be blocked in the locked position.

5. Lock according to claim 4, wherein the interlocking plate, which can be blocked in the locked position by the blocking unit, is releasable by a displacement of the blocking unit towards the front plate and that the rotation of the circular bolt from the retracted position to the extended position is triggerable by the release of the interlocking plate.

6. Lock according to claim 5, wherein the blocking unit comprises a permanent magnet, whose position is adjustable within the blocking unit, wherein the displacement of the blocking unit and release of the interlocking plate are effectable by a counter-magnet.

7. Fitting for operating a lock according to claim 1, comprising
a housing,
a handle, which is rotatably mounted in a bearing, which bearing is firmly connected to the housing, and
a slider, which comprises means for attaching a connecting element for connection to the lock,
wherein a displacement of the slider and of the attached connecting element relative to the housing is effectable by rotating the handle, wherein a locking mechanism is provided, comprising a locking element and an actuating element, which is designed for interaction with a user, wherein
by displacing the actuating element in a direction parallel to the connecting element the locking element is transferable into a position for blocking the displacement of the slider.

8. Fitting according to claim 7, wherein the handle comprises a tab arranged perpendicular to the axis of the handle and that a displacement of the slider as well as of the connecting element attached to the slider relative to the housing is effectable by rotating the tab around the axis of the handle.

9. Strike plate comprising a housing with a front plate having a longitudinal axis, an opening for receiving a circular bolt of a lock according to claim 1 and a magnet held in a plastic socket wherein the magnet is installed eccentrically in the plastic socket and that the position of the magnet is adjustable relative to the longitudinal axis of the front plate by turning the plastic socket.

10. Strike plate according to claim 9, wherein a vertical strike plate unit and a horizontal strike plate unit are provided, with which the shape and size of the opening can be adapted to the circular bolt, of the lock.

11. Closing device for sliding doors comprising
a lock according to claim 1,
a fitting for operating the lock, comprising
a housing,
a handle, which is rotatably mounted in a bearing, which bearing is firmly connected to the housing, and
a slider, which comprises means for attaching a connecting element for connection to the lock,
wherein a displacement of the slider and of the attached connecting element relative to the housing is effectable by rotating the handle, wherein a locking mechanism is provided, comprising a locking element and an actuating element, which is designed for interaction with a user, wherein
by displacing the actuating element in a direction parallel to the connecting element the locking element is transferable into a position for blocking the displacement of the slider, and
a connecting element that connects the lock to the fitting, allowing lateral and frontal locking of the sliding door.

12. Closing device according to claim 11, wherein the fitting features a locking mechanism, wherein the locking mechanism cannot be operated when the circular bolt of the lock is in its retracted position.

13. Closing device according to claim 11 provided with a strike plate comprising a housing with a front plate having a longitudinal axis, an opening for receiving a circular bolt of the lock and a magnet held in a plastic socket wherein the magnet is installed eccentrically in the plastic socket and that the position of the magnet is adjustable relative to the longitudinal axis of the front plate by turning the plastic socket.

14. Closing device according to claim 11, wherein the lock is self-locking and magnetically triggerable.

15. Sliding door system comprising a sliding door and a closing device according to claim 11.
